(19) United States
(12) Patent Application Publication
(10) Pub. No.: US 2014/0006509 A1
(43) Pub. Date: Jan. 2, 2014

(54) SERVER AND METHOD FOR MATCHING ELECTRONIC DEVICE USERS

(71) Applicant: CHI MEI COMMUNICATION SYSTEMS, INC., New Taipei (TW)

(72) Inventor: CHUN-JENG KANG, New Taipei (TW)

(73) Assignee: CHI MEI COMMUNICATION SYSTEMS, INC., New Taipei (TW)

(21) Appl. No.: 13/864,282

(22) Filed: Apr. 17, 2013

(30) Foreign Application Priority Data
Jun. 27, 2012 (TW) 101123048

(51) Int. Cl. H04L 29/08

(52) U.S. Cl. CPC H04L 67/18
USPC 709/204

(57) ABSTRACT

In a method for matching electronic device users, a user name and position information is received from an electronic device. The method determines a target matching item corresponding to the position information, and sends the target matching item and a prompt message to the electronic device, for prompting whether the user wants to join in the target matching item or create a new matching item. When the user wants to join in the target matching item, the method inserts the user name into the target matching item, and updates a total participating number of the target matching item. A success message is sent to all electronic devices recorded in relation to the target matching item when a total participating number accord with a minimum required participating number.

### BACKGROUND

1. Technical Field

Embodiments of the present disclosure relate to matching technology, and particularly to a server and method for matching electronic device users using the server.

2. Description of Related Art

People may want to find other people that have same preferences to go to a same destination (e.g., a park), or to purchase a same product or service because a preferential price may be provided when a number of participants or products is equal to or exceeds a required participating number. However, it is not easy for people to find others having the same preferences in a limited time. Therefore, an efficient method for matching electronic device users using the electronic device is desired.

### BRIEF DESCRIPTION OF THE DRAWINGS

FIG. 1 is a block diagram of one embodiment of a server in connection with a plurality of electronic devices.

FIG. 2 is a block diagram of function modules of a matching system in the server.

FIG. 3 is a chart of a first embodiment of a user interface provided by the matching system.

FIG. 4 is a chart of a second embodiment of the user interface provided by the matching system.

FIG. 5 is a flowchart of one embodiment of a method for generating matching items using the matching system.

FIG. 6 is a flowchart of one embodiment of a method for matching electronic device users using the matching system.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

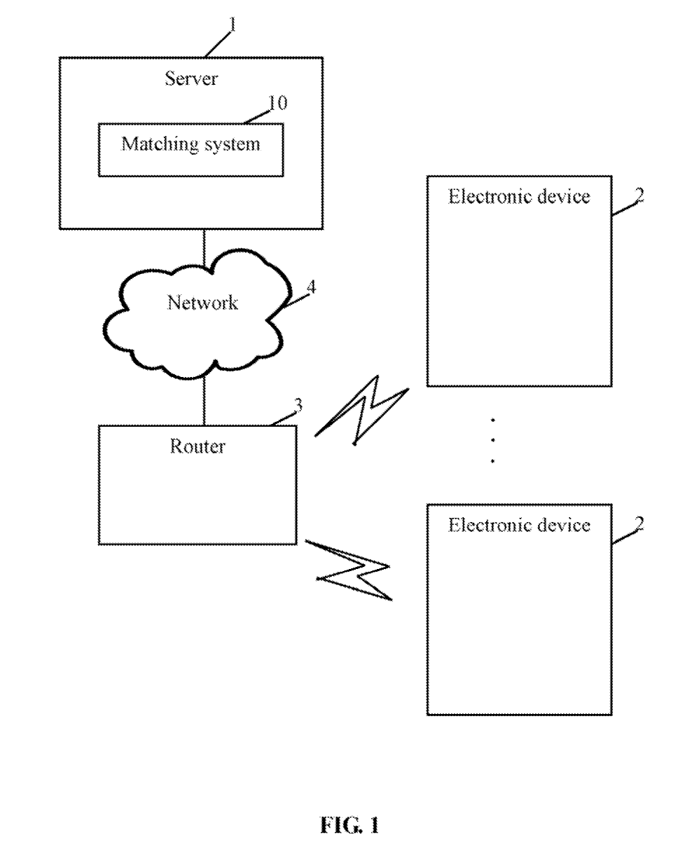

FIG. 1 is a block diagram of one embodiment of a server 1 in communication with a plurality of electronic devices 2. The server 1 is connected to a router 3 through a network 4, and the plurality of electronic devices 2 are in communication with the router 3 through a communication network. The communication network may be a Global System for Mobile Communications (GSM) network, or a WIFI™ network, for example. The network 4 may be the Internet or any other network. In some embodiments, the server 1 may be a computer, a host computer, or other electronic device. The server may be provided by a service provider. The electronic devices 2 may be mobile phones, personal digital assistants (PDAs), tablet computers, notebook computers, or other device.

In some embodiments, the matching system 10 creates a matching item according to a matching request received from one of the electronic device 2, and sends the matching item to invite potential users that are located in the same area as the electronic device 2, thereby connecting people that have a same target (e.g., purchase a same product or join in a same social activity) and are in the same vicinity. When the matching item is successfully matched, the matching system 10 sends a success message to electronic devices 2 of all participants who joined in the matching item.

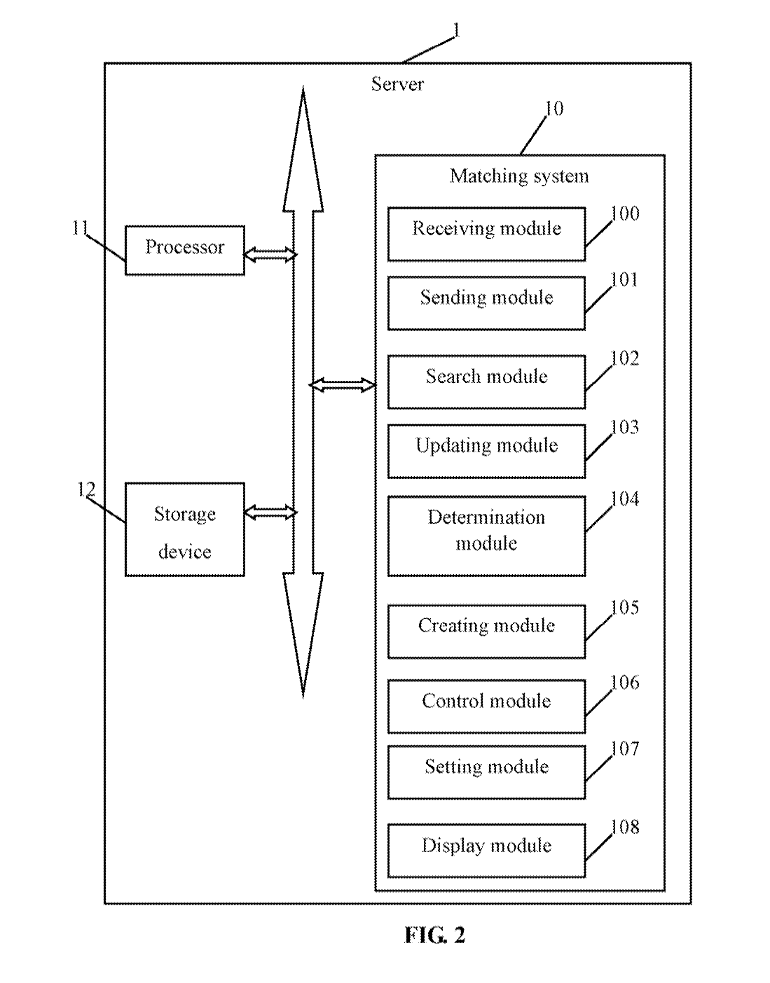

FIG. 2 is a block diagram of function modules of the matching system 10 in the server 1. The server 1 further includes at least one processor 11 and a storage device 12. FIG. 2 illustrates only one example of the server 1, in other examples, the server 1 may include more or fewer components than illustrated, or have a different configuration of the various components in other embodiments.

In one embodiment, the matching system 10 includes computerized instructions in the form of one or more programs that are executed by the at least one processor 11 and stored in the storage device 12. The storage device 12 stores one or more programs, such as operating systems, applications of the server 1, and various kinds of data, such as a plurality of matching items created by the matching system 10. In some embodiments, the storage device 12 may be an external storage card, such as a memory stick, a smart media card, a compact flash card, a secure digital card, or any other type of memory storage device.

In one embodiment, the matching system 10 may include one or more modules, for example, a receiving module 100, a sending module 101, a search module 102, an updating module 103, a determination module 104, a creating module 105, a control module 106, a setting module 107, and a display module 108. In general, the word “module,” as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

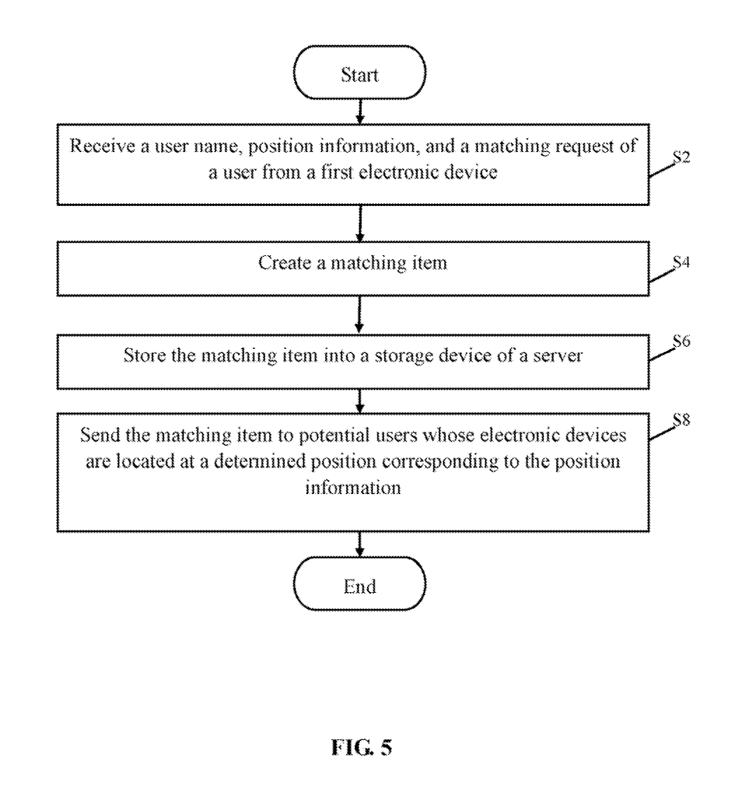

FIG. 5 is a flowchart of one embodiment of a method for generating matching items using the matching system 10. Depending on the embodiment, additional steps may be added, others removed, and the ordering of the steps may be changed.

In step S2, the receiving module 100 receives a user name, position information, and a matching request of a first user from a first electronic device, and determines a position corresponding to the position information. The position information may be an address name, or geographic coordinates including a longitude, a latitude, and an altitude. For example, the address name may be a name of a specified supermarket or any landmark, or a specified address, such as, “1111 W. Imperial Hwy Suite 111, Brea, Calif.,” for example. In some embodiments, the matching request may be a group purchasing request or a connecting people request, and the matching request may include, but is not limited to, a subject matter to which the matching request relates (request contents), a required participating number, and a number of participating people or a product to be purchased (hereinafter referred to as “the participating number”). The required participating number represents a minimum number of participants or a predetermined product to be purchased.

In some embodiments, the request contents include, but are not limited to a subject matter, a product name or a service name, a destination name, a deadline, a limited time, or a departure time.

In some embodiments, the position information may be acquired using a global positioning system (GPS) of the first electronic device, or be determined according to a name of a WIFI hotspot which is connected to the first electronic device. For example, the name of the WIFI hotspot may be “C mall.”

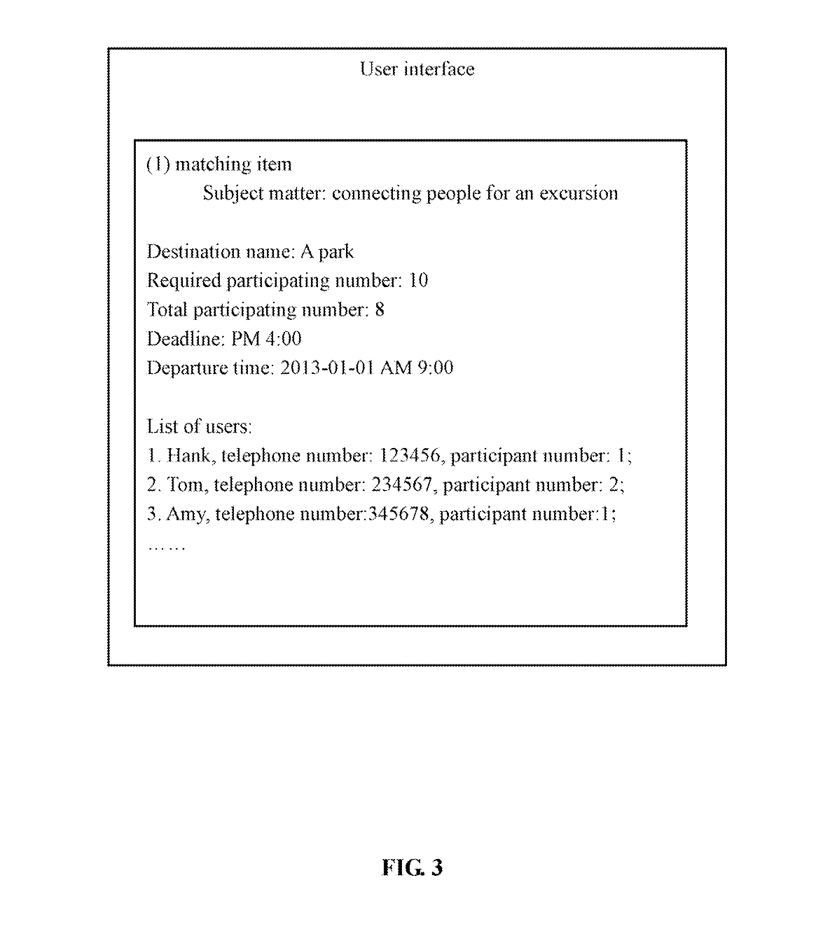

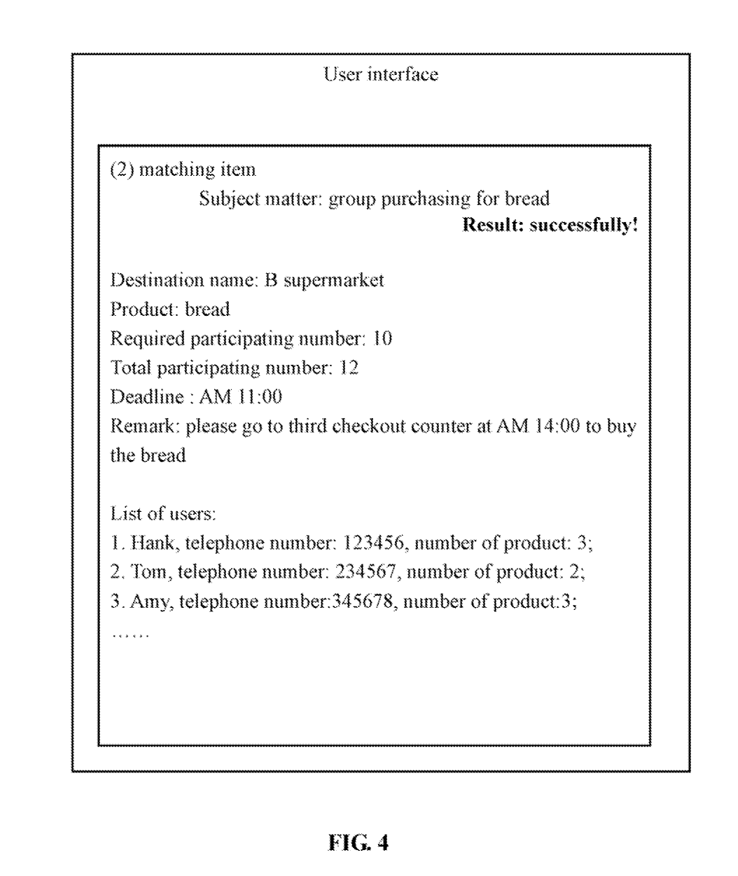

In step S4, the creating module 105 creates a matching item according to the matching request and the determined position. In some embodiments, the setting module 107 sets a user interface of the matching system 10, as shown in FIG. 3 and FIG. 4, the user interface may be provided for the first user to input relevant data, such as the user name, the position information, the matching request, and other information including response procedure. In other embodiments, the first user may send the above mentioned data to the matching system 10 using the first electronic device. For example, a short message service (SMS) message or a multimedia messaging service (MMS) may be used. The user interface further display multiple matching items for different users to review. For example, the matching item may include, but is not limited to, the subject matter, the destination name, the required participating number, a total participating number, the deadline, the departure time, a list of users, and participating numbers of the users. In some embodiments, the total participating number is a sum of participating numbers of multiple users joined in a specified matching item, or a sum of numbers of a product to be purchased by the multiple users.

The user interface may further include a plurality of function buttons that are not shown in FIG. 3 and FIG. 4, such as an “add” button, a “cancel” button, a “join in” button, and a “quit” button, for example. The “add” button can be used to add a new matching item by inputting new matching request.

The display module 108 displays one or more matching items stored in the storage device 12 on the user interface.

For example, FIG. 3 shows a first embodiment of the user interface provided by the matching system 10. It is assumed that a matching item in FIG. 3 is the matching item created above. The matching item is requested by Hank, a subject matter of the matching item is “connecting people for an excursion,” a destination name is “A park,” a required participating number is 10, and a total participating number is 8. When a total participating number of the participants is equal to or greater than the required participating number before a predetermined deadline (e.g., PM 4:00), the matching item is determined to be successful.

When Hank sends the matching request to the matching system 10, his telephone number (e.g., 123456) and a participant number requested by Hank are recorded and displayed in the list of users.

For another example, FIG. 4 shows a second embodiment of the user interface. In the second embodiment, a subject matter is a group purchasing for bread.

In some embodiments, the creating module 105 further classifies the matching items in the storage device 12 according to different positions (e.g., determined positions of multiple electronic devices 2) corresponding to the matching items.

In step S6, the creating module 105 stores the matching item into the storage device 12.

In step S8, the sending module 101 sends the matching item to invite potential users whose electronic devices 2 are located at the determined position, or in the vicinity of the determined position. That is, other users located in the same area as the first electronic device are regarded as the potential users. The potential users may determine to join the matching item, add a new matching item, or ignore the matching item, and may send response information to the matching system 10. The response information may be sent by the electronic device 2 or inputted through the user interface.

By utilizing the above flow in FIG. 5, a plurality of matching items may be created and stored in the storage device 12.

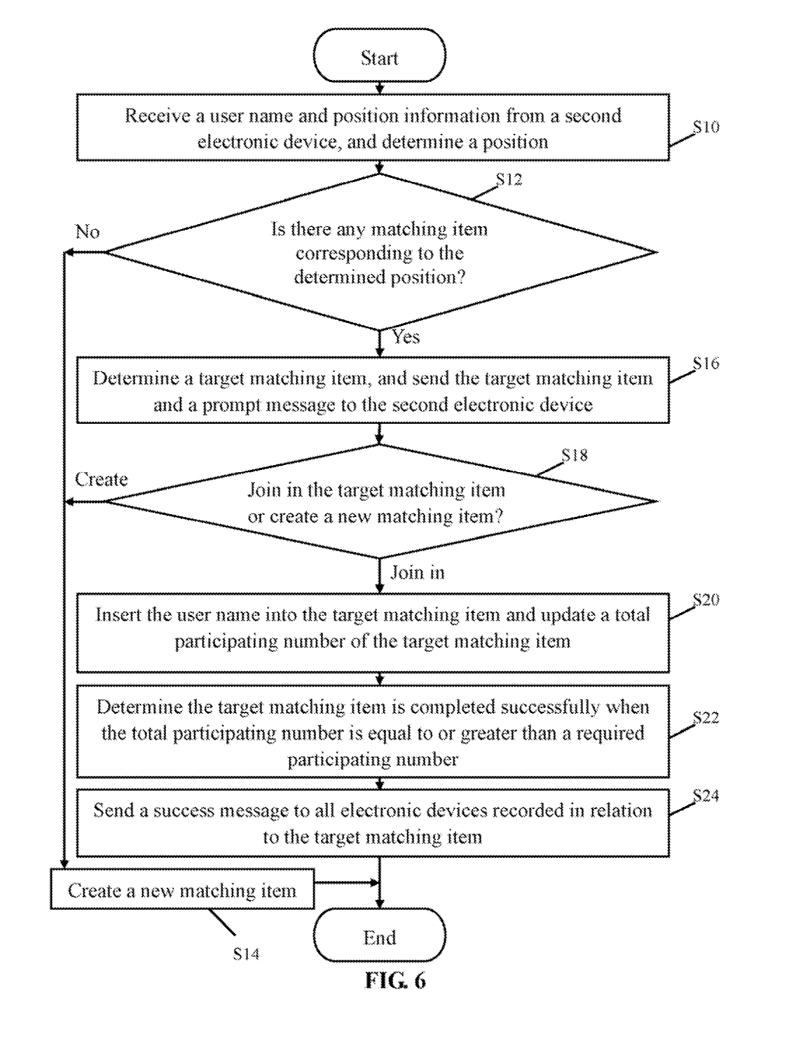

FIG. 6 is a flowchart of one embodiment of a method for matching electronic device users using the matching system. Depending on the embodiment, additional steps may be added, others removed, and the ordering of the steps may be changed.

In step S10, the receiving module 100 receives a user name and position information of a second user from a second electronic device, and determines a position corresponding to the position information. For example, the second user sends the user name and the position information to the matching system 10 to inquire matching items occurred at the determined position. The first user and the second user may be a single person, and the first electronic device and the second electronic device may be the same.

In step S12, the search module 102 determines whether there is any matching item corresponding to the determined position. When there is no matching item corresponding to the determined position, the procedure goes to step S14. When there is a matching item corresponding to the determined position, the procedure goes to step S16.

In step S14, the creating module 105 creates a new matching item in response to receiving a new matching request from the second user, according to detailed steps described in FIG. 5, and then the procedure ends.

In step S16, the search module 102 determines a matching item corresponding to the determined position as a target matching item, sends the target matching item and a prompt message to the second electronic device. In some embodiments, the prompt message may invite the second user to join in the target matching item, or inquire whether to create a new matching item.

In step S18, the receiving module 100 receives response information from the second electronic device, and determines whether the second user wants to join in the target matching item or request to create a new matching item according to the response information. In some embodiments, the response information includes joining information, the new matching request, or other information.

When the second user desires to join in the target matching item, the procedure goes to step S20. When the second user requests a new matching item, the procedure goes to step S14.

In step S20, the updating module 103 inserts the user name into the target matching item, and updates a total participating numbers in relation to the target matching item. For example, the updating module 103 may insert the user name of the second user into a list of users of the target matching item shown on the user interface. As mentioned above, the total participating number is a sum of participating numbers of multiple users in the list of users, or a sum of numbers of a product to be purchased by the multiple users in the list of users.

In step S22, the determination module 104 determines that the target matching item is completed successfully when the total participating number is equal to or greater than a required participating number of the target matching item, and generates a success message.

In step S24, the sending module 101 sends the success message to all electronic devices 2 recorded in relation to the target matching item, and the procedure ends. All electronic devices 2 recorded in relation to the target matching item represent all participants of the target matching item.

In other embodiments not shown in FIGS. 5 and 6, the control module 106 may determine an overdue matching item when a limited time or a deadline of the overdue matching item has passed, invalidate the overdue matching item, and delete the overdue matching item from the storage device 12. The control module 106 also may clear the overdue matching item stored in the storage device 12 according to a predetermined time interval (e.g., one week).

In addition, when the limited time or the deadline of the overdue matching item has passed, the control module 106 sends a prompt message to all electronic devices 2 recorded in relation to the overdue matching item, to prompt whether the overdue matching item wants to be extended. When the overdue matching item wants to be extended, the control module 106 resets the limited time or the deadline of the overdue matching item. The limited time or the deadline may be reset from a total time of the server 1, or according to input parameters from the electronic device 2.

It should be emphasized that the above-described embodiments of the present disclosure, particularly, any embodiments, are merely possible examples of implementations, set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure is protected by the following claims.

What is claimed is:

1. A computer-implemented method for matching electronic device users using a server, the server comprising a storage device and a processor, the storage device storing matching items, each of the matching items comprising a required participating number and a total participating number, the method comprising:
receiving a user name and position information of a user from an electronic device;
determining a position corresponding to the position information;
determining a matching item that corresponds to the determined position as a target matching item, sending the target matching item and a prompt message to the electronic device, the prompt message prompting whether the user wants to join in the target matching item or create a new matching item;
receiving response information from the electronic device;
inserting the user name into the target matching item using the processor and updating a total participating number of the target matching item, when the response information indicates that the user wants to join in the target matching item; and
sending a success message to all electronic devices recorded in relation to the target matching item when the total participating number is equal to or greater than a required participating number of the target matching item.

2. The method according to claim 1, further comprising:
when there is no matching item corresponding to the determined position or when the response information indicates that the user wants to create a new matching item, receiving a matching request from the electronic device, the matching request comprising request contents and a required participating number;
creating the new matching item according to the matching request and the determined position; and
sending the new matching item to potential users whose electronic devices are located at the determined position.

3. The method according to claim 2, wherein the matching request is a group purchasing request or a connecting people request, and the required participating number represents a minimum number of participants or a predetermined product to be purchased.

4. The method according to claim 1, further comprising:
setting a user interface;
receiving input data by the server from the electronic device through the user interface, the input data comprising the user name, the position information, and the response information; and
displaying one or more matching items corresponding to the determined position on the user interface.

5. The method according to claim 1, further comprising:
setting a limited time or a deadline for each of the matching items stored in the storage device; and
invalidating an overdue matching item when a limited time or a deadline of the overdue matching item has passed.

6. The method according to claim 5, further comprising:
when the limited time or the deadline of the overdue matching item has passed, sending a prompt message to all electronic devices recorded in relation to the overdue matching item, to prompt whether the overdue matching item wants to be extended; and
resetting the limited time or the deadline of the overdue matching item when the overdue matching item wants to be extended.

7. The method according to claim 1, further comprising:
classifying the matching items in the storage device according to different positions corresponding to the matching items.

8. A server, comprising:
a storage device that stores matching items, each of the matching items comprising a required participating number and a total participating number;
at least one processor; and
one or more modules that are stored in the storage device and are executed by the at least one processor, the one or more modules comprising:
a receiving module that receives a user name and position information of a user from an electronic device, and determines a position corresponding to the position information;
a search module that determines a matching item that corresponds to the determined position as a target matching item, sends the target matching item and a prompt message to the electronic device, the prompt message prompting whether the user wants to join in the target matching item or create a new matching item;
the receiving module that receives response information from the electronic device;
an updating module that inserts the user name into the target matching item using the processor and updates a total participating number of the target matching item, when the response information indicates that the user wants to join in the target matching item; and
a sending module that sends a success message to all electronic devices recorded in relation to the target matching item when the total participating number is equal to or greater than a required participating number of the target matching item.

9. The electronic device according to claim 8, wherein the one or more programs further comprise a creating module,
the receiving module receives a matching request from the electronic device, when there is no matching item corresponding to the determined position or when the response information indicates that the user wants to create a new matching item, the matching request comprising request contents and a required participating number;
the creating module creates the new matching item according to the matching request and the determined position; and
the sending module sends the new matching item to potential users whose electronic devices are located at the determined position.

10. The electronic device according to claim 9, wherein the matching request is a group purchasing request or a connecting people request, and the required participating number represents a minimum number of participants or a predetermined product to be purchased.

11. The electronic device according to claim 8, wherein the one or more modules further comprise:
a setting module that sets a user interface;
the receiving module receives input data by the server from the electronic device through the user interface, the input data comprising the user name, the position information, and the response information; and
a display module that displays one or more matching items corresponding to the determined position on the user interface.

12. The electronic device according to claim 8, wherein the one or more modules further comprise a control module that invalidates an overdue matching item when a limited time or a deadline of the overdue matching item has passed.

13. The electronic device according to claim 12, wherein the control module further:
sends a prompt message to all electronic devices recorded in relation to the overdue matching item, to prompt whether the overdue matching item wants to be extended, when the limited time or the deadline of the overdue matching item has passed; and
resets the limited time or the deadline of the overdue matching item when the overdue matching item wants to be extended.

14. The electronic device according to claim 8, wherein the matching items in the storage device are classified according to different positions corresponding to the matching items.

15. A non-transitory storage medium having stored thereon instructions that, when executed by a processor of an electronic device, causes the electronic device to perform a method for matching electronic device users using a server, the server comprising a storage device and a processor, the storage device storing matching items, each of the matching items comprising a required participating number and a total participating number, the method comprising:
receiving a user name and position information of a user from an electronic device;
determining a position corresponding to the position information;
determining a matching item that corresponds to the determined position as a target matching item, sending the target matching item and a prompt message to the electronic device, the prompt message prompting whether the user wants to join in the target matching item or create a new matching item;
receiving response information from the electronic device;
inserting the user name into the target matching item using the processor and updating a total participating number of the target matching item, when the response information indicates that the user wants to join in the target matching item; and
sending a success message to all electronic devices recorded in relation to the target matching item when the total participating number is equal to or greater than a required participating number of the target matching item.

16. The non-transitory storage medium according to claim 15, wherein the method further comprises:
when there is no matching item corresponding to the determined position or when the response information indicates that the user wants to create a new matching item, receiving a matching request from the electronic device, the matching request comprising request contents and a required participating number;
creating the new matching item according to the matching request and the determined position; and
sending the new matching item to potential users whose electronic devices are located at the determined position.

17. The non-transitory storage medium according to claim 16, wherein the matching request is a group purchasing request or a connecting people request, and the required participating number represents a minimum number of participants or a predetermined product to be purchased.

18. The non-transitory storage medium according to claim 15, wherein the method further comprises:
setting a user interface;
receiving input data by the server from the electronic device through the user interface, the input data comprising the user name, the position information, and the response information; and
displaying one or more matching items corresponding to the determined position on the user interface.

19. The non-transitory storage medium according to claim 15, wherein the method further comprises:
setting a limited time or a deadline for each of the matching items stored in the storage device; and
invalidating an overdue matching item when a limited time or a deadline of the overdue matching item has passed.

20. The non-transitory storage medium according to claim 19, wherein the method further comprises:
when the limited time or the deadline of the overdue matching item has passed, sending a prompt message to all electronic devices recorded in relation to the overdue matching item, to prompt whether the overdue matching item wants to be extended; and
resetting the limited time or the deadline of the overdue matching item when the overdue matching item wants to be extended.
